(19) United States
(12) Patent Application Publication
(10) Pub. No.: US 2003/0092829 A1
(43) Pub. Date: May 15, 2003

(54) Binders based on oleochemical reaction products

(76) Inventors: Wolfgang Klauck, Meerbusch (DE); Ernst-Ulrich Rust, Berg-Gladbach (DE); Ludger Willeke, Oberhausen (DE); Peter Daute, Essen (DE); Johann Klein, Duesseldorf (DE); Alfred Struve, Hilden (DE)

Correspondence Address: HENKEL CORPORATION, 2500 RENAISSANCE BLVD, STE 200, GULPH MILLS, PA, 19406, US

(21) Appl. No.: 10/305,201

(22) Filed: Nov. 25, 2002

Related U.S. Application Data
(63) Continuation of application No. 08/633,732, filed on Apr. 22, 1996, now abandoned.

(30) Foreign Application Priority Data
Oct. 20, 1993 (DE) P 43 35 672.9
Aug. 31, 1994 (DE) P 44 30 875.2

(51) Int. Cl. C08J 3/00

(52) U.S. Cl. 524/555

(57) ABSTRACT

Binders based on a reaction product of

A) at least one fatty compound containing on average 1 to 10 and preferably 1.5 to 6 of at least one of the following functional groups —OH, —COOH, —SH, —NH2, —C═C—, epoxide and anhydride group in the fatty compound, the fatty compound containing at least 1 mol-% of at least trifunctional fatty molecules, with

B) at least one mono- or polyfunctional compound capable of reacting with the functional groups of the fatty compounds, with a molecular weight of at least 1,500, are provided. Also provided are methods of using the binders for coating, sealing, casting, or binding.

This invention relates to binders based on oleo-chemical reaction products and to their use for coating, sealing, casting and binding.

“Binders” in the context of the invention are products which are capable of bonding substrates of the same kind or different kinds or of firmly adhering thereto. They are generally based on substances or mixtures of substances which set chemically and/or physically. In addition to inorganic substances, organic substances above all play an important role, synthetic high molecular weight compounds in which the high molecular weight may even be reached in stages being especially significant in this regard. These substances are generally modified by additives in such a way that they are more suitable for bonding, coating, sealing and casting. Corresponding additives are, for example, resins, plasticizers, solvents, fillers, pigments, accelerators, stabilizers and dispersants. Accordingly, the adhesives, sealing compounds, coating compounds or casting resins are based on correspondingly modified binders.

Accordingly, the most important base for binders are synthetic polymers, for example polyacrylates, polyvinyl acetates, polyamides, polyisobutene, polyvinyl ethers, polyurethanes, styrene/butadiene copolymers, ethylene/vinyl acetate copolymers, polyvinyl chloride, phenolic resins, etc.

Unfortunately, all the polymers mentioned above are attended by the disadvantage that they are largely based on structural elements of petrochemical origin, i.e. ultimately emanate from petroleum or natural gas. The multistage reaction steps required for the production of these structural elements are complicated and represent a burden on the environment. Accordingly, corresponding dispersions contribute towards increased depletion of oil and gas occurrences and, on account of their poor biodegradability, pollute waters and waste disposal sites.

For this reason, efforts have been made to produce polymers based on fats and oils. Thus, WO 91/00305 describes polymers obtained by reaction of unsaturated and/or hydroxyfunctional fatty acids or esters thereof with bifunctional ester- and/or amide-forming compounds and subsequent reaction of the difunctional monomer units obtained with a second bifunctional compound. Since only bifunctional compounds are produced and used, linear polymers which can be melted and formed are obtained. Thus, a film was produced at 200° C. and used to bond two plates of glass at 190° C.

An aqueous dispersion of polymers based on fats and oils has also been described, cf. DE 43 05 309. According to this document, an anionic polymer is produced from polyvalent metal ions and carboxylic acids based on fats or oils. The carboxylic acids are monobasic to decabasic and have a molecular weight Mn of preferably more than 400. Carboxylic acids such as these are linked together by metal ions, such as Ca, Mg, Zn, Zr, Se, Al and Ti, via ionic bonds in the main chain. These ionic polymers can also be subsequently processed to aqueous dispersions. Their disadvantages are: all the properties which are attributable to a certain dissociation equilibrium of the ionic groups in the main chain, for example the tendency of the dried films to flow under load or at elevated temperature—a property known to the expert as “cold flow”.

Accordingly, the problem addressed by the present invention was to provide binders based on fats and oils which would be satisfactory not only by virtue of their better environmental compatibility, but also by virtue of a sufficiently high performance level and competitive price and, more especially, by virtue of the particularly high initial tack (or surface tack), the ease of production and the ready biodegradability which can be achieved with binders of the type in question.

The solution provided by the invention is defined in the claims. It is distinguished above all by the fact that the base used for the binders are reaction products obtained by reaction of A) at least one fatty compound containing on average 1 to 10 and preferably 1.5 to 6 of at least one of the following functional groups: —OH, —SH, —NH₂, —C═C—, —COOH, anhydride group or an epoxide group in the fatty component, the fatty compound containing at least 1 mole-% of at least trifunctional fatty compounds, with B) at least one monofunctional or polyfunctional compound which is capable of reacting with the functional groups of the fatty compounds.

The reaction products have an average molecular weight Mn (osmotically determined number average) of at least 1,500, more particularly at least 5,000 and—for certain applications—preferably at least 8,000. The molecular weight may be even further increased after the reaction and before application of the binder, for example after dispersion of the binder. The increase in molecular weight can also lead to slight crosslinking, although the binder remains castable or at least formable during its application. The binder is applied at temperatures of 0 to 250° C. and, more particularly, at temperatures of 20 to 150° C. It is also swellable. The molecular weight is increased in particular after addition of reactive systems, for example after addition of radical initiators, such as benzoyl peroxide, or after addition of curing agents, such as epoxy resins, polyisocyanates and polyamines.

“Fatty compounds” in the context of the invention are fatty acids, fatty alcohols and derivatives thereof which contain at least one of the following functional groups —OH, —SH, —NH₂, —C═C—, —COOH, anhydride group or epoxide groups in the fatty component. The fatty compound is not an individual compound, but rather a mixture. This applies in particular to the functionality. At least 1% of the molecules of the fatty compound have at least three functional groups of the same kind or different kinds, preferably at least 3%. The expert knows how far he can take the reaction in order still to achieve only branching of the molecules or at best such slight crosslinking that the reaction products are still formable. Fatty compounds with a molecular weight (number average) above 300 or oligomerized fatty compounds with a molecular weight above 800 are preferably used. The molecular weight is generally above 200.

The fatty compounds are lipophilic.

“Fatty acids” in the context of the invention are acids which contain one or more carboxyl groups (COOH). The carboxyl groups may be attached to saturated, unsaturated, unbranched or branched alkyl groups containing more than 8 carbon atoms and, in particular, more than 12 carbon atoms. Besides the —OH, —SH, —C═C—, —COOH, amino, anhydride groups or epoxide groups mentioned above, they may contain other groups, such as ether, ester, halogen, amide, amino, urethane and urea groups. However, carboxylic acids, such as native fatty acids or fatty acid mixtures, dimer fatty acids and trimer fatty acids, are preferred. Specific examples of the fatty acids according to the invention besides the saturated types are, in particular, the monounsaturated or polyunsaturated acids palmitoleic, oleic, elaidic, petroselic, erucic, ricinoleic, hydroxymethoxystearic, 12-hydroxystearic, linoleic, linolenic and gadoleic acid.

In addition to naturally occurring fatty acids, polyhydroxy fatty acids may also be used. They may be obtained, for example, by epoxidation of unsaturated fats and oils or esters of fatty acids with alcohols, ring opening with H-active compounds, for example alcohols, amines and carboxylic acids, and subsequent saponification. The fats or oils required as starting material may be both of vegetable origin and animal origin or may optionally be synthesized by particular petrochemical methods.

The fatty acids may also be derived from oil- and fat-based raw materials obtainable, for example, by ene reactions, Diels-Alder reactions, transesterifications, condensation reactions, grafting (for example with maleic anhydride or acrylic acid, etc.) and epoxidation reactions. Examples of such raw materials are a) epoxides of unsaturated fatty acids, such as palmitoleic, oleic, elaidic, petroselic, erucic, linoleic, linolenic, gadoleic acid, b) reaction products of unsaturated fatty acids with maleic acid, maleic anhydride, methacrylic acid or acrylic acid, c) condensation products of hydroxycarboxylic acids, such as ricinoleic acid or 12-hydroxystearic acid, and polyhydroxycarboxylic acids.

Not all the fatty acids mentioned above are stable at room temperature. If necessary, therefore, derivatives of the above-mentioned fatty acids, such as esters or amides, may be employed for the use according to the invention.

A preferred embodiment of the invention is characterized by the use of esters or partial esters of the above-mentioned fatty acids with monohydric or polyhydric alcohols. “Alcohols” in the context of the invention are understood to be hydroxyl derivatives of aliphatic and alicyclic saturated, unsaturated, unbranched or branched hydrocarbons. Besides monohydric alcohols, these alcohols also include the low molecular weight hydroxyfunctional chain-extending or crosslinking agents known per se from polyurethane chemistry. Specific examples from the low molecular weight range are methanol, ethanol, propanol, butanol, pentanol, decanol, octadecanol, 2-ethylhexanol, 2-octanol, ethylene glycol, propylene glycol, trimethylene glycol, tetramethylene glycol, 2,3-butylene glycol, hexamethylenediol, octamethylenediol, neopentyl glycol, 1,4-bis-hydroxymethyl cyclohexane, Guerbet alcohol, 2-methyl propane-1,3-diol, hexane-1,2,6-triol, glycerol, trimethylol propane, trimethylol ethane, pentaerythritol, sorbitol, formitol, methyl glycoside, butylene glycol, the dimer and trimer fatty acids reduced to alcohols. Monophenyl glycol or alcohols derived from colophony resins, such as abietyl alcohol, may also be used for the esterification.

Instead of the alcohols, OH-containing tertiary amines, polyglycerol or partly hydrolyzed polyvinyl esters may also be used.

The esterification with alcohols may also be carried out in the presence of added saturated and branched fatty acids, such as caproic, caprylic, capric, lauric, myristic, palmitic, stearic, isostearic, isopalmitic, arachic, behenic, cerotic and melissic acid. In addition, polycarboxylic acids or hydroxycarboxylic acids may be added for oligomerization. Examples include oxalic acid, malonic acid, succinic acid, maleic acid, fumaric acid, glutaric acid, adipic acid, suberic acid, sebacic acid, 1,11-undecanedioic acid, 1,12-dodecanedioic acid, phthalic acid, isophthalic acid, terephthalic acid, hexahydrophthalic acid, tetrahydrophthalic acid or dimer fatty acid, trimer fatty acid, citric acid, lactic acid, tartaric acid, ricinoleic acid, 12-hydroxystearic acid. Adipic acid is preferably used.

In addition to the partly saponified fats, such as glycerol monostearate, preferred examples of esters according to the invention are the natural fats and oils of rape (new), sunflower, soya, linseed, castor beans, coconuts, oil palms, oil palm kernels and oil trees and methyl esters thereof. Preferred fats and oils are, for example, beef tallow with a chain distribution of 67% oleic acid, 2% stearic acid, 1% heptadecanoic acid, 10% saturated C₂₋₁₆ acids, 12% linoleic acid and 2% saturated acids containing more than 18 carbon atoms or, for example, the oil of new sunflowers (NSf) with a composition of around 80% oleic acid, 5% stearic acid, 8% linoleic acid and around 7% palmitic acid. The corresponding epoxides and reaction products with maleic anhydride, for example, may of course also be used. Other examples are partly and completely dehydrated castor oil, partly acetylated castor oil, ring opening products of epoxidized soybean oil with dimer fatty acid.

Fatty acid esters and derivatives thereof obtainable by epoxidation are preferably used. Examples of such fatty acids include soybean oil fatty acid methyl ester, linseed oil fatty acid methyl ester, ricinoleic acid methyl ester, epoxystearic acid methyl ester, epoxystearic acid 2-ethylhexyl ester. Preferred glycerides are the triglycerides, for example rapeseed oil, linseed oil, soybean oil, castor oil, partly and completely dehydrated castor oils, partly acetylated castor oil, soybean oil epoxide, linseed oil epoxide, rapeseed oil epoxide, epoxidized sunflower oil.

Epoxidized triglycerides of unsaturated fatty acids ring-opened with nucleophiles may be used in another preferred embodiment of the invention. Nucleophiles in the context of the invention are alcohols, for example methanol, ethanol, ethylene glycol, glycerol or trimethylol propane; amines, for example ethanolamine, diethanolamine, triethanolamine, ethylenediamine or hexamethylenediamine; or carboxylic acids, for example acetic acid, dimer fatty acid, maleic acid, phthalic acid or a mixture of C₆₋₃₆ fatty acids.

However, it is best to use fats and oils (triglycerides) both in native form and after thermal and/or oxidative treatment or the derivatives obtainable by epoxidation or by the addition of maleic anhydride or acrylic acid. Specific examples are palm oil, peanut oil, rapeseed oil, cottonseed oil, soybean oil, castor oil, partly and completely dehydrated castor oils, partly acetylated castor oils, sunflower oil, linseed oil, stand oils, blown oils, epoxidized soybean oil, epoxidized linseed oil, rapeseed oil, coconut oil, palm kernel oil and tallows. At least 50% by weight and, more particularly, at least 80% by weight of fatty compounds with the triglyceride structure should still be present after the modification.

Amides of the fatty acids mentioned above may also be used as derivatives. They may be obtained by reaction with primary and secondary amines or polyamines, for example with monoethanolamine, diethanolamine, ethylenediamine, hexamethylenediamine, ammonia, etc.

“Fatty alcohols” in the context of the invention are compounds which contain one or more hydroxyl groups. The hydroxyl groups may be attached to saturated, unsaturated, unbranched or branched alkyl groups containing more than 8 carbon atoms and, in particular, more than 12 carbon atoms. In addition to the —SH, —C═C—, —COOH, amino, anhydride or epoxide groups required for the subsequent oligomerization, they may contain other groups, for example ether, ester, halogen, amide, amino, urea and urethane groups. Specific examples of the fatty alcohols according to the invention are ricinoleyl alcohol, 12-hydroxystearyl alcohol, oleyl alcohol, erucyl alcohol, linoleyl alcohol, linolenyl alcohol, arachidyl alcohol, gadoleyl alcohol, erucyl alcohol, brassidyl alcohol, dimer diol (=hydrogenation product of dimer fatty acid methyl ester).

Symmetrical and non-symmetrical ethers and esters with mono- and polycarboxylic acids may be used as derivatives of the fatty alcohols. Monocarboxylic acids include formic acid, acetic acid, propionic acid, butyric acid, valeric acid, caproic acid, oenanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, arachic acid, behenic acid, lignoceric acid, cerotic acid and melissic acid. Polycarboxylic acids are, for example, oxalic acid, adipic acid, maleic acid, tartaric acid and citric acid. At the same time, the fatty acids described above, for example oleic acid oleyl ester, may also be used as the carboxylic acid.

The fatty alcohols may also be etherified, more particularly with the same fatty alcohols or with other fatty alcohols and also with other polyhydric alcohols, for example alkyl polyglycosides, dioleyl ethers, dimer diol ethers, diepoxydistearyl ethers, oleyl butyl ethers.

Mixtures of the above-mentioned fatty compounds may of course also be added.

In the case of unsaturated fatty compounds, it might be appropriate to add siccatives in quantities of 1 to 5% by weight, based on the fatty compound. Specific examples are napthenates, octoates, linoleates or resinates of Co, Mn, Pb or mixtures thereof.

“Mono- or polyfunctional compounds capable of reacting with the functional groups of the fatty compounds” (component B) are understood above all to be at least one of the following compounds: vinyl esters, (meth)acrylates containing up to 18 carbon atoms in the alcohol component, ethylene, styrene, butadiene, acrylonitrile, vinyl chloride, polyhydric alcohols, polyamines, aminoalcohols, polymercaptans, aminomercaptans, alcohol mercaptans, amino acids, hydroxy acids, mercaptan acids, polycarboxylic acids—including those of relatively high molecular weight, such as dimer fatty acids for example—anhydrides, polyepoxides and polyacid chlorides, any aliphatic and aromatic, more especially difunctional, isocyanates and NCO-terminated short-chain prepolymers produced therefrom (Mw<8,000). The molecular weight of component B) is generally below 2,000 (number average).

The percentage content of component B is at most 80% by weight and preferably at most 50% by weight, based on the weight of components A) and B). However, the equivalent ratio of the functional groups of component A) and component B) is crucial. After thorough mixing, however, components A) and B) are only reacted to such an extent that still formable reaction products are initially obtained and may even be converted into thermoset products by further crosslinking.

The reaction results in the formation of more or less branched macromolecules or polymers, including oligomers. The reaction in question is the known reaction used for the synthesis of polymers, i.e. polyadditions, polycondensations and polymerizations, more particularly transesterifications, condensation reactions, ene reactions, grafting reactions (for example with maleic anhydride and subsequent chain extension with polyols or polyamines) and ring opening of epoxide groups. The molecular structure of the triglyceride of the oils and fats remains largely intact. However, it may even be partly lost through transesterification or transamidation or modified as required by such reactions.

It is essential that the polyreaction lead to reaction products having an average molecular weight MW of at least 1,500 and, more particularly, at least 5,000 (as determined by GPC). On the other hand, however, the reaction product should still not gel in the melt. This is because a certain flow behavior is required for the subsequent application, more particularly for dispersion in water at elevated temperature. However, this flow behavior can be improved by addition of external emulsifiers or other additives, for example plasticizers, to the polymer melt.

The reaction can be accelerated by addition of stabilizers to such an extent that it takes place in acceptable times even at room temperature. For example, the reaction of carboxylic anhydride groups with alcohol groups can be greatly accelerated by hetero aromatic amines containing other hetero atoms in the ring. Corresponding catalysts are derivatives of pyrrole, indolizine, indole, isoindole, benzotriazole, carbazole, pyrazole, imidazole, oxazole, isooxazole, isothiazole, triazole, tetrazole, thiazoles, pyridine, quinoline, isoquinoline, acridine, phenanthridine, pyridazines, pyrimidines, pyrazine, triazines and compounds containing corresponding structural elements. Particularly suitable catalysts are 1-methyl imidazole, 2-methyl-l-vinyl imidazole, 1-allyl imidazole, 1-phenyl imidazole, 1,2,4,5-tetramethyl imidazole, 1-(3-aminopropyl)-imidazole, pyrimidazole, 4-dimethylaminopyridine, 4-pyrrolidinopyridine, 4-morpholinopyridine, 4-methyl pyridine.

Accordingly, the end of the polyreaction can be calculated from the average functionality of the fats and oils on the one hand and the functionality of compound B reacted therewith and from the ratio in which these two reactants are mixed. However, a series of tests with increasing concentrations of compound B and increasing reaction times is more practical than this estimation by calculation. It is possible in this way quickly and reliably to obtain information on the position of the particular gel point beyond which thermoplastic processing with a corresponding softening range is no longer possible.

The reaction products are preferably synthesized as follows; polyfunctional compounds containing 1 to 10 and preferably 1.5 to 6 functional groups may be used quite generally instead of the described difunctional compounds.

1.) Reaction Products Based on Fatty or Oil Epoxides

The production of typical oleochemical epoxides and oils and fats suitable for this purpose are described in DE 43 05 309. The fatty or oil epoxides may be both partly epoxidized and fully epoxidized. The preferred functionality of the epoxide-ring-opening reaction products is between 1.5 and 5.0 and, more particularly, 2, diols, diamines and dicarboxylic acids being particularly suitable for ring opening. To control molecular weight or to initiate opening of the epoxide ring by itself, monofunctional amines, alcohols and carboxylic acids may also be added in small amounts. Fatty or oil epoxides are ring-opened with polyfunctional alcohols, amines, aminoalcohols, mercaptans, aminomercaptans, alcohol mercaptans, carboxylic acids, amino acids, hydroxy acids, mercaptan acids, etc. However, any diamines and diols suitable for the production of polyurethanes may also be used. Dicarboxylic acids, including those of relatively high molecular weight, such as dimer fatty acid for example, are also suitable for reaction with the oleochemical epoxides. The OH groups formed by ring opening and the other OH or NH₂ groups may also be reacted with polyisocyanates, more particularly diisocyanates. The reaction of isocyanates with amines and alcohol groups, which are present at the derivatized or polymerized fatty and oil molecules, may also be carried out after dispersion in water. Curing with radical initiators, such as dibenzoyl peroxide, is also possible. Both water-insoluble and water-dispersible isocyanates are suitable for subsequent crosslinking.

2.) Reaction Products Based on OH and NH₂ Groups of Fats and Oils

Fatty and oil derivatives containing functional OH and NH₂ groups, for example castor oil, the reaction products of oleochemical epoxides with monoalcohols or monoamines, may be reacted with reactive multifunctional, more particularly difunctional, molecules such as, for example, anhydrides, diisocyanates, diepoxides and diacid chlorides to form polymers, the number of functional groups having to be between 1.5 and 5. Any aliphatic and aromatic, more especially difunctional, isocyanates and NCO-terminated short-chain prepolymers produced therefrom (Mn: <20,000 and, more particularly, <8,000) are suitable for this purpose. In this case, too, the dispersions may be subsequently reacted with polyisocyanates, as described under 1.).

Particularly suitable diepoxides are those used for two-component reaction adhesives or coatings.

Suitable anhydrides are, for example, the saturated and unsaturated types used in the synthesis of polyesters and polyamides.

3.) Reaction Products Based on Unsaturated Fats and Oils Containing Anhydride Groups

Unsaturated fats and oils can be grafted with anhydrides, more especially maleic anhydride, at elevated temperature. Corresponding reactions are described in DE 43 05 397, for example for rapeseed oil or soybean oil. The fatty and oil molecules provided with anhydride groups can be reacted with the compounds already mentioned, more particularly difunctional compounds, for example diamines, dialcohols (diols), aminoalcohols and their mercaptan variants to form polymeric molecules. In this case, too, the location of the gel point and whether or not it is reached are determined by the stoichiometry in dependence upon the functionality of the fatty or oil molecules, i.e. ultimately by the average number of anhydride groups attached to a triglyceride molecule.

However, fatty compounds containing C═C double bonds may also be initially reacted with dienophiles such as, for example, maleic anhydride, methacrylic acid and acrylic acid and then further reacted with polyamines, polyols or aminoalcohols, the average number of functional groups preferably being from 1.5 to 5.

Before the grafting or addition reaction, it might be appropriate to react the fatty compounds containing C═C double bonds in the presence of oxygen, radical initiators or at elevated temperature. This may be done both in the absence and above all in the presence of radical-polymerizable compounds containing olefinic C═C double bonds, more especially in the presence of at least one of the following monomers: styrene, vinyl esters, vinyl chloride, butadiene, ethylene, acrylic acid, (meth)acrylates, crotonic acid, acrylonitrile or mixtures of these monomers.

The reactions may be carried out in solution, in dispersion or in the melt. The most appropriate form is determined above all by the application envisaged for the binder. In general, however, the reaction is advantageously carried out in the melt and the reaction product subsequently converted into an aqueous dispersion.

The dispersion is generally prepared as follows: the polymers are heated to 50° C. to 150° C. and preferably to 80° C. to 130° C. and then dispersed in water with intensive shearing. Conversely, the water may be introduced into the melt. Before dispersion, other additives, for example polymers, plasticizers, resins, antiagers, etc., may be added in quantities of up to at most 50% and preferably in quantities of up to at most 30%. Depending on the viscosity of the melt, the water may also be heated with advantage to around the temperature of the melt. At mixing temperatures above 95 to 100° C., pressure emulsification is necessary.

Emulsifiers which are either added (external emulsifiers such as, for example, nonionic surfactants and ether sulfonic acids and also ether carboxylic acids) or which are already incorporated in the polymer (internal emulsifiers) are required for dispersion. Internal emulsifiers may be, for example, NaOH- or amine-neutralized COOH groups (anionic dispersion) which are present as lateral groups, for example, in method 3.) for the production of the polymers. Acid-protonated or alkylated amine groups in the polymer chains (cationic dispersion) may also perform the function of internal emulsification. External emulsifiers may be both low molecular weight compounds and polymers. Corresponding emulsifiers or surfactants are known to the expert and are described in numerous reference books (for example Tensid-Taschenbuch, Dr. Helmut Stache, 2nd Edition, 1981, Carl-Hanser-Verlag, München/Wien, more particularly pages 771 to 978). In addition, ionic or nonionic stabilized polymer dispersions (for example acrylates or polyurethanes) may also be added as emulsifiers, their emulsifying effect being known to increase with increasing hydrophilicity. Protective colloids of the type used in the preparation of polymer dispersions (for example polyvinyl acetate), for example starch, starch derivatives, cellulose derivatives, polyvinyl alcohols, etc., may also be added.

Accordingly, dispersions in which the reaction product is finely dispersed in water are obtained. The reaction product can be so finely dispersed that the dispersion is clear in appearance (molecular or colloidal dispersion). In general, however, the dispersion is cloudy.

After dispersion, the molecular weight of the reaction product is best increased using known hardening agents and/or initiators. Slight crosslinking is also possible. However, swellability should still be guaranteed.

In the oleochemical macromolecules obtained in accordance with the invention the structural elements are attached to one another by covalent bonds. This results in performance properties totally different from those of the known ionomers based on fats and oils. This applies in particular to heat resistance and temperature-dependent strength and flow behavior and to behavior towards water. Despite their high percentage content of fatty compounds, the binders according to the invention result in bonds which at least have the strength of contact adhesives. However, they need not be permanently tacky.

Accordingly, the binders according to the invention are suitable for coating, sealing, casting and binding, more especially for bonding or binding inorganic formulations, such as cement and gypsum.

Depending on the particular application envisaged, additives, for example waxes, fillers, pigments, dispersants, stabilizers, viscosity regulators, preservatives, solvents and resins, are best added to the binders for the production of adhesives, casting resins, sealing compounds or coating compositions. The additives are known as are the methods by which they are incorporated.

However, the binders according to the invention may also be added to commercial polymer dispersions or glues in quantities of 2 to 90% by weight and more particularly in quantities of up to 50% by weight, based on the binding polymer in the polymer dispersion or in the glue. The polymer dispersions and the glues are based on the usual polymers, such as casein, glutin, cellulose ethers, starch, dextrin, polyvinyl pyrrolidone, polyvinyl alcohol, polymethacrylates, polyvinyl chloride, polybutadiene, polystyrene, styrene/acrylate copolymers, styrene/butadiene copolymers, polyvinyl esters and polyurethanes. These polymer dispersions and glues have a solids content of 20 to 80% by weight.

The expert knows the rules governing the compatibility of such mixtures. For example, cationically and anionically stabilized dispersions are generally incompatible and a significant displacement in the pH value can also lead to the coagulation of a dispersion or mixture of dispersions. Nonionically stabilized dispersions are normally the least sensitive to variations in pH and addition of ions.

By virtue of their properties, the binders according to the invention are suitable for the production of adhesives, adhesive sealing compounds, adhesive casting resins and coating compositions, more particularly where less importance is attributed to peak strength values than to price. They are particularly suitable for substrates differing in their elastic behavior or thermal expansion coefficients, as is generally the case with different substrates. Suitable substrates are wood, paperboard, paper, wall coverings, such as wallpapers, cork, leather, rubber, felt, textiles, plastics (more particularly floor coverings of PVC, linoleum and polyolefins either in the form of films or sheet-form textiles), mineral substrates, such as glass, quartz, slags, rock and ceramics and also metals.

The binders according to the invention are particularly suitable for the production of dispersion adhesives, contact adhesives, solvent-based adhesives, adhesive sticks, plastisols and hotmelt adhesives. They are also particularly suitable as jointing compounds, as adhesive casting resins and as coating compositions for hard substrates and for textiles and paper.

The invention is illustrated by the following Examples:

### EXAMPLES

### Example I

29 g of Jeffamin D 2000 (amine-terminated polypropylene glycol, Mn 2000) are added at 80° C. to 50 g of the reaction product of 1 mole of soybean oil with 3 moles of maleic anhydride (stirred under nitrogen for 6 hours at 240° C. and then distilled), the Jeffamin being added dropwise over a period of 10 minutes. The temperature of the highly viscous mixture is increased to 100° C. and 47.7 g of water containing 3.8 g of sodium hydroxide and preheated to 50° C. are quickly added with intensive mixing. A transparent to opaque high-tack dispersion with a viscosity of 10,000 mPa·s and a solids content of 65% is formed after cooling for 20 minutes to room temperature. The dispersion has a pH value of 7.5 and is stable in storage for at least 3 months.

### Example II

Production is carried out as in Example I (stirring under nitrogen for 6 hours at 200° C. and then for 4 hours at 220° C., no distillation) except that the 29 g of Jeffamin 2000 are replaced by the corresponding equimolar quantity of isophoronediamine and the quantity of sodium hydroxide used for neutralization during dispersion remains constant. A dispersion with a solids content of 50% and a pH value of 7.6 is formed. It produces a low-tack film which becomes transparent on drying.

### Example III

50 g of the reaction product of 1 mole of soybean oil with 2 moles of maleic anhydride are reacted with stirring for 1 hour at around 150° C. with 8.6 g of Polydiol 200 (polyethylene glycol with a molecular weight Mn of 200). The temperature of the mixture is then lowered to 90° C. and 65 g of water containing 4.6 g of sodium hydroxide and preheated to 50° C. are quickly added with intensive mixing. A tacky transparent dispersion with a solids content of 50% is formed after cooling to room temperature. The dispersion is stable in storage for at least 6 months.

### Example IV

50 g of the reaction product of 1 mole of soybean oil with 2 moles of maleic anhydride are reacted with 12.7 g of polytetrahydrofuran 2000 (Mn=2000) in the same way as described in Example III. 65 g of water and 5.1 g of sodium hydroxide are used for dispersion. A transparent dispersion with a solids content of 50% is formed. It produces a tacky film which becomes transparent on drying. The dispersion is stable in storage for at least 6 months.

### Example V

50 g of the reaction product of 1 mole of soybean oil with 2 moles of maleic anhydride are reacted with 8.6 g of Polydiol 600 (polyethylene glycol, Mn=600) in the same way as described in Example III. 68 g of water and 8.0 g of sodium hydroxide are used for dispersion. A transparent dispersion with a solids content of 50% is formed. It produces a tacky film which becomes transparent on drying. The dispersion is stable in storage for at least 6 months.

### Example VI

Soybean oil epoxide is ring-opened with dimer fatty acid in a molar ratio of 1:1 (stirred for 1 hour at 160° C.). 40 g of this oleochemical reaction product are dispersed with intensive mixing at 90° C. with 124 g of water containing 3.3 g of sodium hydroxide and preheated to 90° C. A low-viscosity milky dispersion with a solids content of 25% is formed after cooling to 20° C. It produces a transparent low-tack film. The dispersion is stable in storage for at least 6 months.

### Example VII

Castor oil is reacted with phthalic anhydride in a molar ratio of 1:2 (stirred under nitrogen for 2 hours at 140° C.). 40 g of this reaction product are dispersed with intensive mixing at 90° C. with 100 g of water containing 5.2 g of sodium hydroxide and preheated to 90° C. A medium-viscosity milky dispersion with a solids content of 31% is formed after cooling to room temperature. It produces a transparent low-tack film. The dispersion is stable in storage for at least 6 months.

### Example VIII

278.3 g of an adduct of soybean oil with maleic anhydride (MA) in a molar ratio of 1:2 are heated with stirring for 1.5 h to 150-160° C. with 188.1 g of partly dehydrated castor oil having an OH value of 120. After cooling to 90-95° C., a solution of 3.26 g of 50% NaOH in 20 g of hot water (90° C.) is added with intensive stirring. Another 480.1 g of hot water are then slowly added. 1000 g of a dispersion which dries to form a high-tack film are obtained after cooling with stirring to room temperature.

### Example IX

268.1 g of partly dehydrated castor oil (OH value 120), 40.2 g of Desmodur 44 V 10 (technical methylenediphenyl diisocyanate) and 61.7 g of Eumulgin KP 92 (fatty acid mixture containing 9.2 EO) are heated for 2 h to 50° C. 630 g of warm water (60° C.) are then slowly added with stirring. Approximately 1000 g of a beige-colored dispersion are obtained after cooling to room temperature.

### Example X

Reaction of Polyvest C 150 (polycarboxylic anhydride of butadiene, maleic anhydride and succinic anhydride manufactured by Hüls) with a polyester/polyether polyol (reaction product of soybean oil epoxide and methanol in a ratio of 1:6, produced by the dropwise addition method with a 1 hour after-reaction by Henkel KGaA)

Catalyst: N-methyl imidazole

Component A: Polyvest C 150

Component B: polyester/polyether polyol

Reaction temperature: 20° C.

| Component | Component | Cat. | | | |
|---|---|---|---|---|---|
| A | B | % by | Reaction time [days] | | |
| [g] | [g] | weight | 1 | 2 | 5 |
| 30 | 23 | — | Mixture remains highly viscous | | |
| 30 | 23 | 1 | Soft | Rubbery | Hard |
| | | | tacky | tacky | rubbery |
| 40 | 15 | 1 | Soft | Rubbery | Hard |
| | | | tacky | tack-free | rubbery |
| 30 | 15 | 1 | Soft | Rubbery | Hard |
| | | | tacky | tacky | rubbery |

### Example XI

Reaction of a reaction product of soybean oil and maleic anhydride (100 g oil: 30 g MA, component A) with glycerol+5 EO (component B) at 20° C.

Catalyst: N-methyl imidazole

| Component | Component | Cat. | | | |
|---|---|---|---|---|---|
| A | B | % by | Reaction time [hours] | | |
| [g] | [g] | weight | 1 | 2 | 5 |
| 20 | 4 | — | Mixture remains highly viscous | | |
| 20 | 4 | 1.4 | Rubbery | Rubbery | Hard |
| | | | tacky | tack-free | rubbery |

### Example XII

Reaction of a reaction product of linseed oil and maleic anhydride (100 g oil: 20 g MA, component A) with glycerol+30 EO (component B)

Catalyst: 1.6% by weight N-methyl imidazole

Component A: 10 g

Component B: 8 g

Slightly tacky after 60 mins.

Hard after 10 h.

### Example XIII

Reaction of a reaction product of linseed oil and maleic anhydride (100 g oil: 30 g MA, component A) with glycerol+30 EO (component B)

Catalyst: 1.4% by weight N-methyl imidazole

Component A: 10 g

Component B: 10.8 g

Surface-dry after 30 mins.

Hard after 3 h.

The oleochemical reaction products of Examples X to XIII are suitable for use as a tacky casting resin which cures even at room temperature.

1. Binders based on a reaction product of
A) at least one fatty compound containing on average 1 to 10 and preferably 1.5 to 6 of at least one of the following functional groups —OH, —COOH, —SH, —NH2, —C═C—, epoxide or anhydride group in the fatty component, the fatty compound containing at least 1 mole-% of at least trifunctional fatty molecules, with
B) at least one mono- or polyfunctional compound capable of reacting with the functional groups of the fatty compounds, with a molecular weight of at least 1,500.

2. Binders as claimed in claim 1, characterized in that at least one substance from the following group of fatty compounds is used: saturated, unsaturated, unbranched or branched fatty acids, fatty alcohols containing at least 8 carbon atoms and esters thereof, more particularly triglycerides of high fatty acids, preferably natural fats and oils, both in native form and after thermal and/or oxidative treatment or epoxidation or after addition of nucleophiles, the fatty compounds having a molecular weight of >200, more particularly >300 and preferably >800.

3. Binders as claimed in claim 1 or 2, characterized in that the fatty compounds are lipophilic.

4. Binders as claimed in claim 1, 2 or 3, characterized by a molecular weight of the functional compound B) of less than 20,000, more particularly less than 8,000 and preferably less than 2,000.

5. Binders as claimed in at least one of claims 1 to 4, characterized by fatty compounds containing epoxide groups and by the following polyfunctional compounds B): polyols, polyamines, aminoalcohols and polycarboxylic acids, more especially dimer fatty acid and dimer alcohol, the average number of functional groups having to be preferably 1.5 to 5.

6. Binders as claimed in at least one of claims 1 to 4, characterized by fatty compounds containing OH and/or NH₂ groups and by the following polyfunctional compounds B): polycarboxylic anhydrides, polyisocyanates, polyepoxides and/or polycarboxylic acid chlorides, the average number of functional groups having to be preferably 1.5 to 5.

7. Binders as claimed in at least one of claims 1 to 4, characterized by fatty compounds containing C═C double bonds which were first reacted with dienophiles such as, for example, maleic anhydride, methacrylic acid and acrylic acid and then further reacted with polyamines, polyols or aminoalcohols, the average number of functional groups having to be preferably 1.5 to 5.

8. Binders as claimed in at least one of claims 1 to 4, characterized in that the fatty compounds containing C═C double bonds were reacted in the presence of oxygen, radical initiators or at elevated temperature.

9. Binders as claimed in at least one of claims 1 to 4 and 8, characterized by fatty compounds containing C═C double bonds which were reacted in the presence of radical-polymerizable compounds containing olefinic C═C double bonds, more especially in the presence of at least one of the following monomers: styrene, vinyl esters, vinyl chloride, butadiene, ethylene, acrylic acid, (meth)acrylates, crotonic acid, acrylonitrile or mixtures of these monomers.

10. Binders as claimed in at least one of claims 1 to 9, characterized in that they are produced in the form of an aqueous dispersion, in particular by dispersing the reaction product in liquid form in water—optionally after heating to 50-150° C.—or, conversely, water in the reaction product, preferably with intensive shearing, best using auxiliaries such as bases, for example NaOH and amines, emulsifiers, for example nonionic surfactants, ether sulfonic acids and ether carboxylic acids, and/or protective colloids.

11. Binders as claimed in claim 10, characterized in that the molecular weight of the reaction products is increased after dispersion best using curing agents and/or initiators.

12. The use of the binders claimed in at least one of the preceding claims for coating, sealing, casting and binding, preferably in admixture with commercial polymer dispersions or glues with a percentage content of 2 to 90% by weight, based on the binding polymer.

13. The use claimed in claim 12, characterized by polymer dispersions and glues based on casein, glutin, cellulose ether, starch, dextrin, polyvinyl pyrrolidone, polyvinyl alcohol, polymethacrylates, polyvinyl chloride, polybutadiene, polystyrene, styrene/acrylate copolymers, styrene/butadiene copolymers, polyvinyl esters and polyurethanes with a solids content of 20 to 80% by weight.

14. The use of the dispersion claimed in at least one of claims 1 to 13, characterized in that the adhesive is an adhesive dispersion, a contact adhesive, a multipurpose adhesive, a solvent-based adhesive or an adhesive stick, in that the sealing compound is a jointing compound and in that substrates with hard surfaces and also textiles and paper are coated.

15. The use claimed in at least one of claims 12 to 14, characterized by the bonding, coating and sealing of wood, paperboard, paper, wall coverings, such as wallpapers, cork, leather, rubber, felt, textiles, plastics, more especially floor coverings of PVC, linoleum and polyolefins either in the form of films or in the form of sheet-form textiles, mineral substrates, such as glass, quartz, slags, rock and ceramics and also metals.
